(19) United States
(12) Patent Application Publication
(10) Pub. No.: US 2020/0160466 A1
(43) Pub. Date: May 21, 2020

(54) CONTENT CONTRACT IN BLOCKCHAIN, AND CONTENT MANAGEMENT SYSTEM AND CONTENT PROVISION METHOD USING SAME

(71) Applicant: Nonprofit Organization Cyber Campus Consortium TIES, Nara (JP)

(72) Inventor: Masumi Hori, Nara (JP)

(21) Appl. No.: 16/717,387

(22) Filed: Dec. 17, 2019

Related U.S. Application Data
(63) Continuation of application No. PCT/JP2018/023991, filed on Jun. 25, 2018.

(30) Foreign Application Priority Data
Jun. 28, 2017 (JP) 2017-125972

(51) Int. Cl. G06Q 50/18; G06F 16/27; G06F 21/10; H04L 9/06; H04L 9/30

(52) U.S. Cl. CPC G06Q 50/184; G06F 16/27; G06F 21/105; H04L 2209/38; H04L 9/30; G06F 2221/0773; H04L 9/0637

(57) ABSTRACT

In the present invention, when a provider of content publishes content on a Web page, an SNS, or the like online, such as on the Internet, a blockchain is used to prevent undesired browsing, quoting, and downloading. A content contract, which is a new tool for enforcing ownership according to the present invention, is stored in a blockchain. A contract portion describing an enforcement condition for performing licensing, and a method portion describing an enforcement program for performing licensing in accordance with the above-described enforcement condition are described in the content contract, and a metadata portion is provided in the content contract. Attribute information and location information such as a URL or URN for referencing an online external storage storing the data of the content is described in the metadata portion.

### BACKGROUND OF THE INVENTION

### Field of the Invention

The present invention relates to a new content contract that uses a blockchain with high tampering resistance and high operation reliability in order to increase the value of content serving as a digital asset when providing any content online. The present invention also relates to a content management system using the content contract, and a content provision method.

### Description of the Related Art

A blockchain has high tampering resistance and high operation reliability, and thus use of a blockchain in copyright management and licensing management for content has conventionally been proposed. A blockchain is a technology that is widely used in transactions of virtual currency. A P2P network in a blockchain is decentralized architecture that does not use a specific server. For this reason, a blockchain is an excellent technique that has high tampering resistance and high operation reliability while eliminating the need for central management.

For example, with a management system such as that shown in FIG. 4, blockchain technology is used for copyright management of content. Note that if static content is to be subjected to copyright management and licensing management by the present invention, the content is, for example, a moving image me, an image file, or a text file. If the target content is a program that is needed in order to process the data of the file, the target content is, for example, a library for an OS, JAVA (registered trademark), or the like, a conversion program such as an encoder, or a display program such as a Web browser or an e-book reader. On the other hand, if the target content is a dynamic program for realizing a desired function, the target content is, for example, a program including a script or code for live broadcasting, TV conference, a chat function, and the like. Hereinafter, these will be referred to collectively as “content” in order to simplify the description.

With reference to FIG. 4, a user 12 of content (in FIG. 4, an image file is taken as an example) 10 acquires the content 10 in his or her information processing apparatus 19 from a provider 14 of the content 10 through Web distribution from a server 11, accessing another network such as an SNS, or the like. On the other hand, the provider 14 records metadata 15 describing attribute information, such as the author name, the creation date and time, and location information, in a blockchain 17 via an appropriate blockchain node 16. Accordingly, copyright management of the content 10 is performed using the high tampering resistance and high operation reliability of the blockchain 17.

With the conventional technique shown in FIG. 4, the recorded metadata 15, that is, the attribute information of the copyright, cannot be tampered with and is held long-term, and no restriction can be placed on the use of the content 10. For this reason, the user 12 can repeatedly use the content 10 at no charge and without restriction. Also, since there is also no restriction on secondary use, such as alteration, there is a possibility that the content 10 will be used in an undesired manner, unbeknownst to the provider 14.

In view of this, Patent Document 1 indicates that in addition to copyright management, licensing of the content 10 is performed using the blockchain 17. The system disclosed in Patent Document 1 is shown in FIG. 5. In the configuration of FIG. 5, portions similar to or corresponding to those in the configuration of FIG. 5 are denoted by identical reference numerals, and description thereof is omitted. In this conventional technique, the provider 14 has a management server 11′ called a terminal for a rights holder installed, and the management server 11′ encrypts the content 10 using an encryption key 20, and provides the content 10 as encrypted content 10′ to the user 12 via another network 13. Accordingly, even when the user 12 receives the content 10′ in the information processing apparatus 19, the user 12 cannot perform use such as reproduction in that state. For this reason, the user 12 references the metadata 15 (attribute information) using the information processing apparatus 19 and requests licensing to the provider 14 via the blockchain 17. Furthermore, when the user 12 performs payment of a usage fee through an appropriate route and the management server 11′ performs licensing, a decryption key 18 is sent from the management server 11′ to the information processing apparatus 19, and the user 12 can use the content 10.

With the above-described conventional technique, licensing is performed using the function of an electronic signature of the blockchain 17 and a key management function of the management server 11′, and therefore it is possible to improve “identifiability” of who (the provider 14) provided the content 10 to whom (the user 12), and to avoid use of the content 10 unbeknownst to the provider 14. However, although Patent Document 1 eliminates the need for a content licensing system using a large-scale centralized management database, as in conventional DRM (digital rights management), the management server 11′, which includes the key management function for the encryption key 20 and the decryption key 18, is still needed. For this reason, in Patent Document 1, the maintenance management cost will become expensive accompanying an increase in the licensing processing for the content 10, and this cost leads to an increase in the cost of the content 10. Also, although the blockchain 1 has high operation reliability as described above, the management server 11′ is often constituted by a single normal server or the like called a rights holder terminal, as described above, and thus a problem occurs in the availability (continuous running) of the system.

### CITATION LIST

### Patent Document

Patent Document 1: JP 2017-50763A

### SUMMARY OF INVENTION

In view of this, the present invention aims to provide a content contract in a blockchain that can appropriately enforce ownership held by an owner when providing content, such as licensing, by skillfully using features of the blockchain, and to provide a content management system using the content contract, and a content provision method.

With the content contract in a blockchain, the content management system using the content contract, and the content provision method of the present invention, in order for the owner of the content to enforce appropriate ownership, a content contract, which is a new ownership enforcement tool of the present invention, is recorded in a blockchain in response to browsing, quoting, downloading, or the like of any online content, such as one or more Web pages, or digital data or a program, which are often acquired from a Web page. Then, a contract portion describing an enforcement condition for enforcing ownership, and a method portion describing an enforcement program for enforcing ownership in accordance with the enforcement condition are described in the content contract, metadata of the content is provided in the content contract, and attribute information and location information such as a URL or a URN for referencing an online external storage, which is any network different from the blockchain, are described in the metadata.

Therefore, although online content has conventionally often been subjected to browsing, quoting, and downloading against the will of the owner, according to the present invention, there is no need to prepare a large-scale centralized management database, or even a small-scale management server for merely managing encryption keys, and it is possible to publish content prepared at the location indicated by the location information by skillfully using technical features such as tampering resistance, identifiability, availability, and publicness achieved with a blockchain.

### BRIEF DESCRIPTION OF THE DRAWINGS

FIG. 1 is a block diagram showing a configuration of a content management system in which a content contract in a blockchain according to an embodiment of the present invention is applied.

FIG. 2 is a diagram for illustrating a relationship between structures of content, a content contract, and a content capsule, for realizing a content management system according to an embodiment of the present invention.

FIG. 3 is a block diagram showing a configuration of a content management system in which a content contract for a blockchain according to another embodiment of the present invention is applied.

FIG. 4 is a block diagram showing an example in which a blockchain is used to strengthen copyright management in a content provision system of a typical conventional technique.

FIG. 5 is a block diagram showing an example of using a blockchain to strengthen licensing in a content provision system of another conventional technique.

### DETAILED DESCRIPTION OF INVENTION

### Embodiment 1

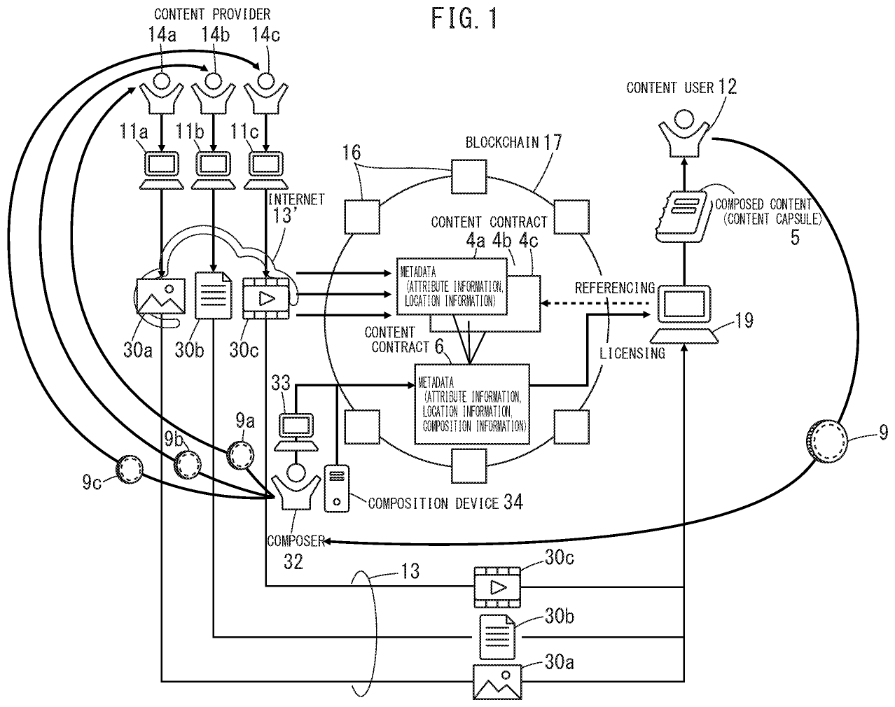

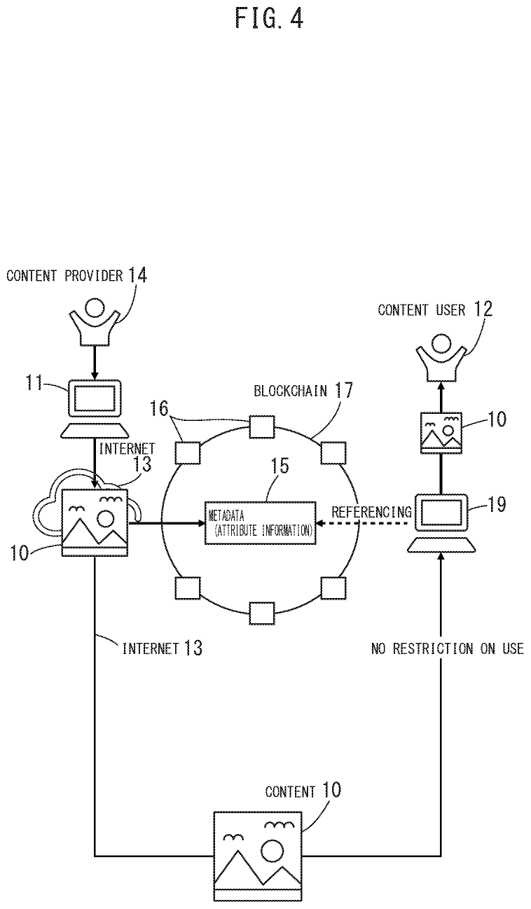

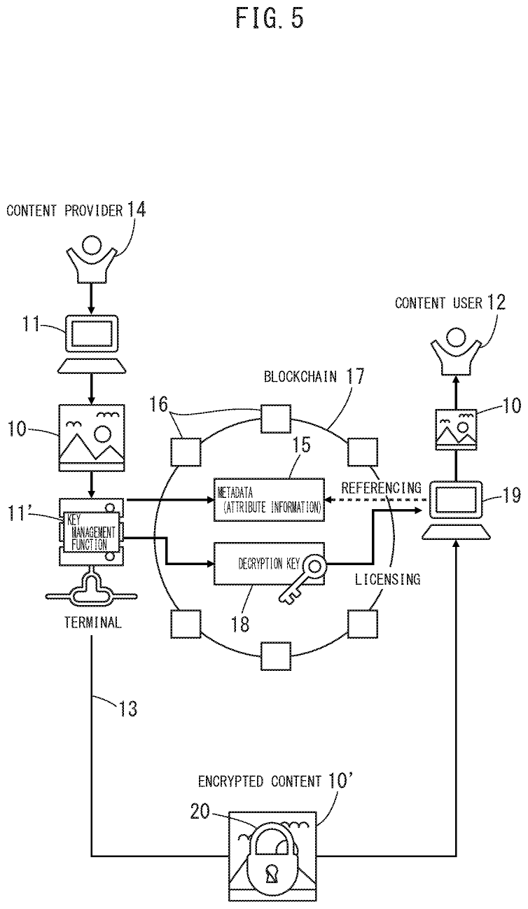

FIG. 1 is a block diagram showing a configuration of a content management system in which a content contract in a blockchain according to an embodiment of the present invention is applied. The content management system is characterized in that content contracts 4a, 4b, and 4c (collectively indicated by reference numeral 4), which will be described in detail later, and a content contract 6 are applied. Although the content contracts 4 and 6 and the content management system of the present embodiment are characterized in that a blockchain 17 is used to perform licensing as shown in FIG. 5 described above with respect to content 30a, 30b, and 30c (collectively indicated by reference numeral 30), copyright management such as that shown in FIG. 4 can also be performed by performing the licensing.

The present content management system is constituted by including: the blockchain 17, information processing apparatuses 11a, 11b, and 11c (collectively indicated by reference numeral 11), an information processing apparatus 33 or a composition device 34, an information processing apparatus 19, an online external storage (not shown), and a network (Internet 13) connecting these elements.

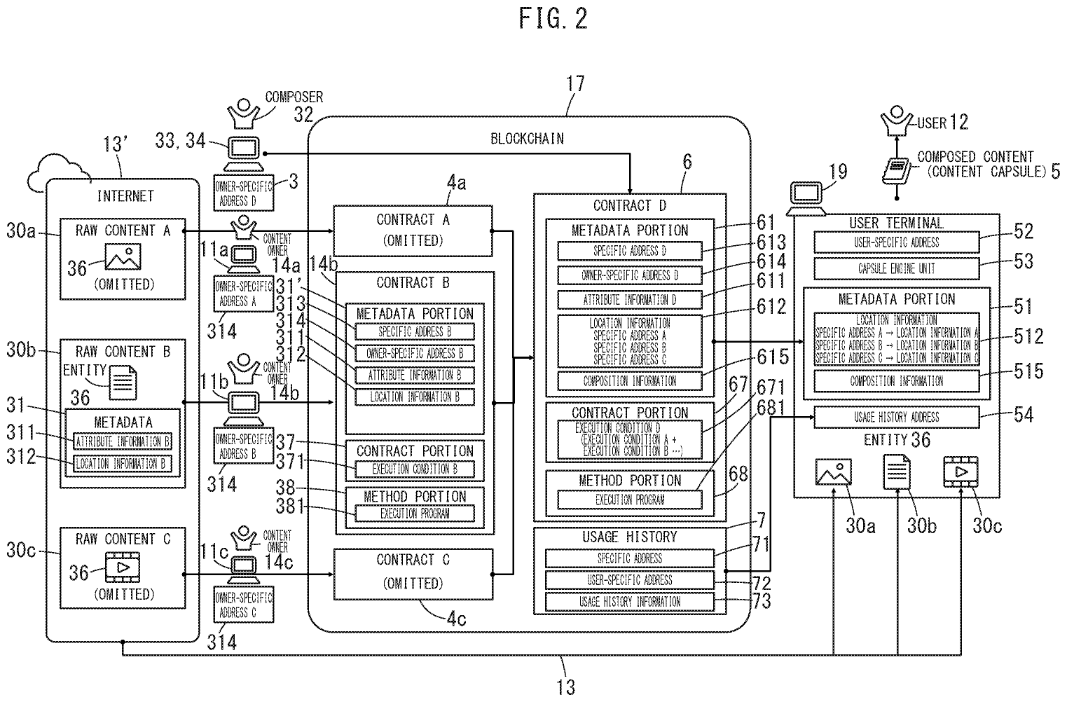

The content contracts 4 and 6 are described as objects in the blockchain 17. Providers (owners) 14a, 14b, and 14c of the content 30a, 30b, and 30c respectively are provided with the information processing apparatuses 11a, 11b, and 11c (collectively indicated by reference numeral 14), and the information processing apparatuses 11a, 11b, and 11c create the content contracts 4a, 4b, and 4c and record the created content contracts 4 in the blockchain 17. A composer 32 is provided with the information processing apparatus 33 or the composition device 34, and the information processing apparatus 33 or the composition device 34 creates a later-described content contract 6. A user 12 is provided with the information processing apparatus 19, and the information processing apparatus 19 receives licensing of the content 30 (6) via the blockchain 17. The external storage stores actual data 36 (see FIG. 2) of the content 30.

Thus, a management system can be realized in which the actual data 36 of the content 30 (6) can be accessed via any network (online) when a transaction of any content 30 (6) is performed, but the content contracts 4 and 6 recorded in the blockchain 17, which has high tampering resistance, are used for enforcement of the ownership of the provider (owner) 14, such as licensing.

In the example of FIG. 1, the content 30a is a still image file, the content 30b is a document file, the content 30c is a moving image file, and the content 30a, 30b, and 30c is uploaded from the information processing apparatuses 11a, 11b, and 11c to the Internet 13 by the providers (owners) 14a, 14b, and 14c. In the present invention, the providers (owners) 14 of the content 30 are often individuals, and the information processing apparatuses 11 may also be a cloud environment 13′ such as any Web site, instead of specific servers.

Along with the upload of the content 30, the providers (owners) 14 record content contracts 4 including metadata 31a, 31b, and 31c (collectively indicated by reference numeral 31), in which attribute data such as author names, creation dates and times, and location information as shown in FIG. 2 are described, in the blockchain 17 via any block chain node 16. Accordingly, copyright management of the content 30 and management of enforcement of ownership such as later-described licensing are performed using the high tampering resistance and high operation reliability of the blockchain 17. In FIG. 1, portions similar to or corresponding to those in FIGS. 4 and 5 are denoted by identical reference numerals, and description thereof is omitted.

Also, the present embodiment is characterized in that the provider 14 who is the owner of the content 30 that is the raw material is not only the provider of the content 30, and the information processing apparatus 33 of the composer 32 who secondarily uses the content 30 and recomposes (curates) the content 30, such as combining the content 30 as appropriate, designating the reproduction order or processing order during combination, creating a layout, adding a description or annotation, is included in the system. The content contract 6, which is obtained by compiling the content contracts 4 of the recomposed (curated) content, is also treated as content in the present embodiment, and is registered in the blockchain 17. Note that the recomposition (curation) of the content 30 may also be performed automatically under a pre-determined rule, without the involvement of the composer 32, and this kind of apparatus is indicated as the composition device 34.

On the other hand, the user 12 can check an overview of the content 30 (6) by accessing the content contracts 4 and 6 from the information processing apparatus 19 of the user 12 via the blockchain node 16. In the present embodiment, a blockchain that can execute a program code relating to an agreement or a business rule (contract), such as Ethereum or Hyperledger Fabric, can be suitably used as the blockchain 17.

Next, the content contracts 4 and 6 and the content capsule 5 will be described in detail. FIG. 2 is a diagram for illustrating a relationship between the content contracts 4 and 6, the content capsule 5, and the raw content 30, as well as their respective structures. The content 30 is stored on an online network 13 (13′) such as the

Internet, which is different from the blockchain 17. The provider (owner) 14 adds the above-described metadata 31 to the data 36 of the content, such as the data or program of the content 30. The data 36 of the content of the provider (owner) 14 is constituted by a single file, such as a still image file (30a), a document file (30b), or a moving image file (30c), a program, or the like. Normally, attribute information 311 such as the author and creation date and time of the content 30 and the location (an address such as a URL or URN) information 312 on the network 13 of the data 36 of the content are recorded as the metadata 31 in the content 30 published on the network.

In the present embodiment, the raw content 30a, 30b, and 30c is registered in the blockchain 17 in order to clarify ownership. For this reason, the data 36 of content with a large capacity is not registered, but the content contracts 4a, 4b, and 4c including the metadata portions 31′ are registered in the blockchain 17. A specific address 313 of the content 30 and a specific address 314 of the provider (owner) 14 are added to the metadata 31′ during registration in the blockchain 17.

Also, the content contract 4 includes a contract portion 37 describing an enforcement condition 371 such as a usage condition, and a method portion 38 describing an enforcement program 381 for enforcing ownership in accordance with the enforcement condition 371. Thus, the content 30 is registered in the blockchain 17 as a digital asset according to the content contract 4.

On the other hand, multiple pieces of the content 30 are combined as the raw content, are arranged according to a predetermined logic, or are arranged according to a predetermined rule, and are thus recomposed (curated) into unique composed content in some cases by the composer 32 or the composition device 34 (curator). Specifically, if the content 30 is a digital file, the display (reproduction) order is designated, or if the content 30 is a program, the processing order is designated, and the layout information and annotations, and the like are added, and thus the content 30 is made into the unique composed content. The content contract of the composed content is indicated by reference numeral 6.

The content contract 6 of the composed content is also constituted by including a metadata portion 61, a contract portion 67, and a method portion 68. The metadata portion 61 is constituted by including attribute information 611, location information 612, a specific address 613, an owner-specific address 614, and composition information 615. That is, the composition information 615 of the content 30 is added to the content contracts 4 of the raw content 30 in the content contract 6 of the recomposed (curated) content.

The attribute information 611 indicates the name of the composer 32 or the composition device 34 (curator) that recomposed (curated) the composed content, and the creation date and time. The specific address 613 indicates an address in the blockchain 17 of the content contract 6 of the composed content. The owner-specific address 614 is an address in the blockchain 17 for the composer 32 or the composition device 34 (curator). It should be noted that the specific addresses 313 of the combined pieces of raw content (in the example shown in FIG. 2, the three pieces of content 30a, 30b, and 30c) are collectively described in the location information 612. The composition information 615 is the reproduction order or the processing order, the layout information, and the like.

It should also be noted that an enforcement condition 671 obtained by combining the enforcement conditions 371 in the content contracts 4 of the combined pieces of content 30 is described in the content contract 6. The combination of the enforcement conditions 371 is adding up usage fees, finding an average, using the usage fee of the most expensive content, matching the availability period with that of the content having the shortest availability period, and the like. The enforcement condition 671 is processed by the enforcement program 681 of the method portion 68, and enforcement of ownership such as licensing is performed. Here, the provider (owner) 14 and the composer 32 allow further quoting and alteration of the content by the user 12 in some cases, and the conditions and results are sequentially subjected to conditional branching and described in the enforcement conditions 371 and 671 of the content contracts 4 and 6.

The content contracts 4 of the raw content 30 described above can be registered in the blockchain 17 by the provider (owner) 14 accessing it via the appropriate blockchain node 16, and the content contract 6 of the composed content described above can be registered in the blockchain 17 by the composer 32 or the composition device 34 accessing it via the appropriate blockchain node 16. The user 12 also accesses the content contracts 4 and 6 from the information processing apparatus 19 via the appropriate blockchain node 16, and if, for example, an amount of money included in the enforcement conditions 371 and 671 of the contract portions 37 and 67 is paid using a virtual currency 9 such as Bitcoin (see FIG. 1), the enforcement programs 381 and 681 of the method portions 38 and 68 perform enforcement of ownership such as licensing to the user-specific address 52.

Note that the above description also includes an example in which the user 12 directly acquires the raw content 30, but realistically, there are thought to be many cases in which composed content (6) that was edited and composed (curated) is used. For this reason, in FIG. 1, an example is shown in which the composer 32 sells the composed content (6) in exchange for the virtual currency 9, and the composer 32 performs payment with the virtual currencies 9a, 9b, and 9c in accordance with the enforcement conditions 371 to the providers (owners) 14a, 14b, and 14c of the contents 30a, 30b, and 30c.

When enforcement of ownership such as licensing is performed in this manner, the metadata portions 31′ and 61′ are copied to the metadata portion 51 from the content contracts 4 and 6 of the raw content 30 and the composed content (6). Upon doing so, the capsule engine unit 53 installed in the information processing apparatus 19 of the user 12 in advance acquires the location information 312 and 612 of the data 36 of the raw content 30 from the metadata portion 51, and downloads the data 36 from the Internet 13 (13′) to complete the capsule 5. Note that FIG. 2 shows an example in which the user 12 has acquired the capsule of the composed content (6) as the content capsule 5. For this reason, in the metadata portion 51, an aggregate of the specific addresses 313 of the combined pieces of content 30a, 30b, and 30c is downloaded from the location information 612 to the location information 512, and the composition information 615 is downloaded as the composition information 515.

Thereafter, when the user 12 actually uses the contents, the capsule engine unit 53 assembles a screen and performs reproduction or the like in accordance with the composition information 515, or performs processing or the like of a program. Software installed in advance in the information processing apparatus 19, software implemented in the capsule engine unit 53, software acquired from the address recorded in the location information similarly to the file contents of the contents 30a, 30b, and 30c, or the like may be used alone or in cooperation with each other to reproduce the contents and the like.

Here, if the content to be used is a Web page, for example, the content 30 is a page such as a blog or news published on the Web, or a posted article on an SNS or the like. If the content 30 to be used is a file, the content 30 is, for example, a digital file provided online (13, 13′) such as a moving image file (30c), an image file (30a), or a text file (30b). If the content 30 to be used is a program, the content 30 is, for example, a digital file that can be downloaded online (13, 13′), such as a dynamic program that realizes a desired function, such as a script or a code for live broadcasting, TV conferences, a chat function, or the like, a library for JAVA (registered trademark), a conversion program such as an encoder, or a display program such as a Web browser or an e-book reader.

In the present embodiment, a content contract 7 for a usage history is also recorded in the blockchain 17. In the content contract 7, when enforcement of ownership such as licensing is performed as described above, a specific address 71 in the block chain 17 of the usage history and the user-specific address 52 of the information processing apparatus 19 of the user 12 are recorded in the user specific address 72, and the specific addresses 313 and 613, the usage fee, and the like for the used content are recorded in the usage history information 73. In addition, an address 54 of the content contract 7 of the usage history is stored in the content capsule 5. These content contracts 4, 6, and 7 are recorded in the same or different transactions (blocks) in the blockchain 17 as time elapses. However, in the content capsule 5 of the user 12, the capsule engine unit 53 can reference all of the usage history by following the content contract 7 of the usage history from the address 54.

As described above, with the content contracts 4 and 6 in the blockchain of the present embodiment and the content management system using the content contracts 4 and 6, the providers (owners) 14 of the content 30 (6), the composer 32, and the like record the content contracts (which are digital assets) 4 and 6 in the blockchain 17 as new means for enforcing ownership of the present invention when any content 30 (6) is to be published online (13, 13′), such as on a Web page. Then, according to the management system of the present embodiment, the contract portions 37 and 67 describing the enforcement conditions 371 and 671 for enforcing ownership of the contents 30 (6), and the method portions 38 and 68 describing the enforcement programs 381 and 681 for enforcing ownership in accordance with the enforcement conditions 371 and 671, are described in the content contracts 4 and 6 in accordance with the transaction determined in advance in the blockchain 17, such as a contract accompanying the exchange of the virtual currencies 9, 9a, 9b, and 9c (hereinafter collectively indicated by reference numeral 9), such as Bitcoin. Furthermore, according to the management system of the present invention, the content contracts 4 and 6 are provided with the metadata portions 31′ and 61 of the content 30 (6) for which ownership is to be enforced, and the attribute information 311 and 611 such as the title, the author, and the creation date and time of the content, which is basic information for ownership of the content 30 (6), is recorded in the metadata portions 31′ and 61. It should also be noted that according to the management system of the present embodiment, the location information 312 and 612, such as URLs or URNS for referencing the appropriate online (13, 13′) external storage (the information processing apparatus 11 of the provider (owner) 14, or a Web server or the like to which the content 30 has been uploaded), which is an appropriate network different from the blockchain 17, is described in the metadata 31′ and 61.

Accordingly, regarding browsing, quoting, downloading, or the like of any online (13, 13′) content 30 (6) such as one or more Web pages, or digital data or programs that are often acquired from the Web pages, with the content management system of the present embodiment, the provider (owner) 14, the composer 32, or the like of the content 30 (6) can avoid undesired (unintended) or unknown use. In this manner, with the content management system of the present embodiment, enforcement of ownership, such as using the content 30 (6), obtaining profit through use, or disposing of the content 30 (6), can be performed suitably using a blockchain 17 that has high identifiability and high tampering resistance. Moreover, according to the content management system of the present embodiment, it is also possible to perform distribution of profit through virtual currencies 9a, 9b, and 9c.

Specifically, heretofore, it has been thought that online (13, 13′) content 30 (6), and in particular, content that is published via a network such as the Internet 13, may be viewed by other people, and there have been many cases in which use such as browsing, quoting, and downloading against the will of the owner (provider) 14, the composer 32, or the like has been performed. In response to this, with the content management system of the present embodiment, although the content 30 (6) is published online (13, 13′), the content contracts 4 and 6 according to which processing for enforcing ownership such as licensing can be performed are purposely registered in the blockchain 17. Accordingly, with the content management system of the present embodiment, the content 30 (6) prepared at the location of the location information 312 and 612 recorded in the attribute information 311 and 611 can be published with the technical features of tampering resistance, identifiability, availability, and publicness of the blockchain 17.

Accordingly, with the content management system of the present embodiment, a large-scale centralized database such as a content server may or may not be used, and there is not even a particular need for a special management server for encryption keys.

Accordingly, for example, it is possible to realize a revolutionary content providing system in which even an individual can freely sell self-produced movies or self-produced lecture videos without depending on any site or being charged a commission fee. Furthermore, according to the content management system of the present embodiment, it is possible to also ensure a function of storing usage history and the like as well based on the history information 73 recorded in the block chain 17, it is also possible to manage how much of the content 30 (6) was used and how much the transaction value rises when a transaction is performed with the virtual currency 9, or the like, and it is possible to further increase the value of the content 30 (6).

Also, according to the content management system of the present embodiment, any owner (provider) 14, composer 32, or the like of the content 30 (6) can record the enforcement conditions 371 and 671, that is, the asset values, using the content 30 (6) prepared so as to be publishable online (13, 13′) as digital assets with high reliability, due to the information processing apparatuses 11, 33, and 34 of the provider (owner) 14, the composer 32, and the like merely accessing the blockchain 17. On the other hand, according to the content management system of the present embodiment, due to the information processing apparatus 19 of the user 12 merely accessing the blockchain 17, any user 12 can search for the content 30 (6), and anyone can allow the provider (owner) 14, the composer 32, and the like to enforce ownership such as use of the content 30 (6) as long as the above-described enforcement conditions 371 and 671 are followed. The above-described enforcement conditions 371 and 671 are the exchange value of the contents using the virtual currency 9 such as Bitcoin, the availability period, the number of people to which the content is available, a specific user who designates use, or the like. In other words, according to the content management system of the present embodiment, even on a server built by the owner (provider) 14, the composer 32, or the like, or on a server built by a third party such as Facebook (registered trademark) or twitter (registered trademark), the owner (provider) 14, the composer 32, or the like can create a page at a preferred location, and can receive money directly from the user 12 since the blockchain 17 is used.

Furthermore, according to the content management system of the present embodiment, the actual data 36 of a digital file or program with a large capacity is not stored as-is in the content contracts 4 and 6, but the location information 312 and 612 of the access destination, such as the URL or URN of an external storage, is merely stored in the metadata portions 31′ and 61. For this reason, according to the content management system of the present embodiment, even digital files or programs whose content is relatively large as-is, content (weather information, stock prices, etc.) and programs that are to be successively updated, documents and images constituted by one or more pieces of content 30 (6), such as a moving image file, an image file, or a text file, and special programs for processing these can be exchanged via the blockchain 17, which has a relatively small data capacity.

Here, the above-described Patent Document 1 can perform licensing, but in Patent Document 1, there is no mention of compiling raw content 30 into composed content 5 (content capsule, content contract 6) of the present embodiment. Accordingly, in Patent Document 1, no consideration is given to redistribution of profit through the above-described virtual currency 9 or the like from the composer 32 or the composition device 34 to the provider (owner) 14. In this respect, according to the content management system of the present embodiment, it is possible to perform redistribution according to the enforcement condition 371.

Also, according to the content management system of the present embodiment, an example of enforcing ownership is realized with licensing, the usage conditions are described as the enforcement conditions 371 and 671 in the contract portions 37 and 67, and the enforcement programs 381 and 681 enforce the licensing in accordance with the usage conditions.

For this reason, the information processing apparatuses 11, 33, and 34 of the owner (provider) 14, the composer 32, and the like create the above-described new content contracts 4 and 6 through a step of storing the data 36 of one or more pieces of content 30 (6) to be provided in an external storage, a step of describing the location information 312 and 612 specific to the above-described content 30 (6) stored in the external storage in the metadata portions 31′ and 61 of the contracts 4 and 6, a step of describing the usage conditions (371 and 671) of the above-described content 30 (6) in the contract portions 37 and 67 of the above-described content contracts 4 and 6, and a step of describing the program code of the enforcement programs 381 and 681 for enforcing the content 30 (6) in the blockchain 17 in accordance with the usage conditions (371, 671) in the method portions 38 and 68 of the content contracts 4 and 6, and the information processing apparatuses 11, 33, and 34 record the content contracts 4 and 6 in the blockchain 17. Meanwhile, the information processing apparatus 19 of the user 12 performs a step of accessing the blockchain 17 to obtain licensing under the usage conditions (371, 671) and to obtain the location information 312 and 612, and a step of accessing the external storage of the location information 312 and 612 to use the content 30 (6).

Accordingly, with the content management system of the present embodiment, when ownership of the content 30 (6) that serves as a digital asset is to be enforced due to the owner (provider) 14, the composer 32, or the like registering the location information 312 and 612, the attribute information 311 and 611, and the like in the blockchain 17, it is possible to take the most advantage of the features of the blockchain 17, such as the high tampering resistance and payment with the virtual currency 9, in the usage and furthermore, the obtainment of profit resulting from the usage, which is preferable. Also, with the content management system of the present embodiment, the owner (provider) 14, the composer 32, and the like recognize usage as an example of enforcing ownership, and by viewing the usage history information 73 that results from recognizing usage, the owner (provider) 14, the composer 32, and the like can devise improvements to and variation of the content 30 (6), and can perform correct value evaluation of the content 30 (6), such as increasing its value as a digital asset, that is, increasing the usage fee of content that has a high usage frequency, and thus, it is possible to contribute to the creation of better content.

Furthermore, with the content contract 6 of the present embodiment, when multiple pieces of the content 30 are combined, edited and processed (curated), the online (13, 13′) location information 612 of the content 30 is recorded in the metadata portion 61, and in order to arrange the content 30 according to a pre-determined logic or according to a predetermined rule, in the metadata portion 61, the display order is recorded in the composition information 615 if the content 30 is, for example, a digital file, or the processing order is recorded along with layout information, annotations, and the like as needed in the composition information 615 if the content 30 is a program.

Accordingly, even if the content 30 is freely published online (13, 13′), the added value of the content (content contract 6, content capsule 5) curated by the composer 32 or the composition device 34 can be significantly improved. Also, even if the location of each piece of content 30 is discovered, if the display order or processing order is unclear, although the text can be read, pictures and annotations cannot be seen, the intended content (6) cannot be expressed, or the like, and thus normal usage cannot be performed, and the value added through the curation cannot be received. As a result, according to the content contract 6 of the present embodiment, unauthorized use can be prevented. Furthermore, according to the content contract 6 of the present embodiment, multiple pieces of the content 30 can be handled collectively, and the load associated with system development and operation maintenance for distribution can also be reduced.

In this case, with the content contract 6 of the present embodiment, in the enforcement condition 671 of the contract portion 67, the enforcement conditions 371 are combined or grouped together as needed, such as adding together the usage fees for multiple pieces of the content 30 that are combined, or applying the highest usage fee, and therefore the enforcement program 681 of the method portion 68 can easily perform ownership enforcement management such as licensing.

Also, with the content contract 6 of the present embodiment, the original pieces of content 30 that are combined, edited and processed, that is, curated (encapsulated), have their actual data 36 stored online (13, 13′), the location information 312 is registered together with the attribute information 311 and the like in the blockchain 17 according to the content contract 4, and thus the content 30 is made into a digital asset in advance, and ownership is clear. Also, with the content contract 6 of the present embodiment, curation, for which unauthorized use was not conventionally suppressed as described above, can be performed safely by going through a procedure that conventionally did not exist for curation, namely combining pieces of content 30 for which ownership rights are clear.

Accordingly, with the content contract 6 of the present embodiment, a content provider (composer 32, composition device 34) can perform curation (encapsulating) and can appropriately perform licensing of the raw content 30 when providing content (6, 5) that can be obtained by combining any pieces of content 30, or by asserting the content provider's opinion quoting views and opinions of a third party. That is, according to the content contract 6 of the present embodiment, the assertion of rights by the providers (owners) 14 of the raw content 30 can be made clear, and distribution of income through billing and the like, measures for preventing tampering, and the like can be performed suitably.

Furthermore, with the content management system of the present embodiment, licensing is obtained by any user 12 for the content contracts 4 and 6, and each time usage is performed, the usage history is recorded in the blockchain 17 according to the content contract 7. Examples of the usage history include: the usage date and time for each instance of usage, the addresses 313 and 613 in the blockchain 17 of the used content contracts 4 and 6, the usage history information 73 based on which the usage fee amount and the like were set, the specific address 72 of the user 12, and the specific address 71 of the usage history information 73.

Accordingly, in the content management system of the present embodiment, the usage history information for each user 12 can be collected due to each user 12 accessing the addresses. This makes it possible for each user 12 to reference his or her own usage history at any time. For example, in the case of e-learning, the usage history is highly-reliable study status (growth) data that is resistant to tampering and according to which identification is possible, according to the technical features of the blockchain 17, and therefore the usage history can be used to issue a graduation certificate or a course completion certificate that may be useful for advancing education, finding employment, or the like. Furthermore, with the content management system of the present embodiment, due to the dispersed and public nature of the blockchain 17, it is possible to record studying at multiple institutions over one's lifetime, and thus even if the institution is changed, such as a case of advancing education, changing schools, studying abroad, or finding employment, the knowledge and skill of the user 12 can be judged overall, and the knowledge that the user 12 has learned can be evaluated also by a teacher, an educational institution, or an employing organization.

Also, with the content management system of the present embodiment, the collected usage history information 73 is highly anonymous data according to the technical features of the blockchain 17, and therefore the problem regarding the handling of personal information, which has conventionally been a problem in the collection of usage history data on the Web, can also be solved. For this reason, with the content management system of the present embodiment, it is also possible to collect large-scale big data while protecting privacy.

Furthermore, with the content contracts 4 and 6 of the present embodiment, licensing, which is performed by accepting the usage conditions (371, 671), is performed using the virtual currency 9 in the blockchain 17. Here, the blockchain is infrastructure developed for the main purpose of exchanging virtual currency 9. In view of this, with the content management system of the present embodiment, when the provider (owner) 14 or composer 32 of the content 30 (6) performs licensing, the virtual currency 9 is used as a registration fee in billing processing for continued use. Accordingly, the provider (owner) 14 and the composer 32 can directly perform transactions with the user 12 without going through a specific service provider who provides a content selling service, and thus the need for commission fees and the like related to transactions can be eliminated. In this case, the usage conditions include not only the price and availability period of the virtual currency 9 and the number of people to which the content is available, but further usage conditions such as whether or not alteration including combination of the content 30 (6) is possible are added to the usage conditions.

Preferably, with the content management system of the present embodiment, the content 30 (6) is study material. An instructor who is the provider (owner) 14 or the composer 32 of the content 30 (6) installs the location information (URL, URN) 312 and 612 of static content such as a lecture video or documents to be provided to a learner, who is the user 12, in the content contracts 4 and 6, and thereby the information processing apparatus 19 of the user 12, upon obtaining the licensing, can autonomously acquire the actual data 36 of the needed content 30 (6) and the study materials as intended by the instructor can be provided. Thus, according to the content management system of the present embodiment, a dedicated study management system or Website does not need to be prepared, and e-learning can be provided continuously at a low cost and with high reliability. In particular, when e-learning is provided, conventionally, it has been necessary to provide a distribution server that stores all of the needed study materials, and furthermore includes a mechanism for billing payment. In contrast to this, with the content management system of the present embodiment, as described above, the location information (URL, URN) 312 and 612 of the needed content (study material) 30 (6) is installed in the content contracts 4 and 6, and by merely performing licensing with the blockchain 17, which has high tampering resistance, the information processing apparatus 19 of the user 12 who has obtained permission autonomously collects the actual data 36 of the content 30 (6), and thus the need for a distribution server is eliminated. Also, the content management system of the present embodiment eliminates the need for a centralized server as well, and therefore billable e-learning can be implemented continuously by any organization, such as cram schools, preparatory schools, private enterprises, and individuals, not just dedicated educational institutions such as institutions of higher learning.

Preferably, with the content management system of the present embodiment, the content 30 (6) is a program for a study assistance function. Also, due to an instructor who is the provider (owner) 14 or composer 32 of the content 30 (6) installing the location information (URL, URN) 312 and 612 of dynamic content, such as a live lecture or a TV conference that is to be provided to a learner who is the user 12 in the content contracts 4 and 6, the information processing apparatus 19 of the user 12 can, upon obtaining licensing, autonomously acquire the program for the needed study assistance function, and thus the study content as intended by the instructor can be provided.

### Embodiment 2

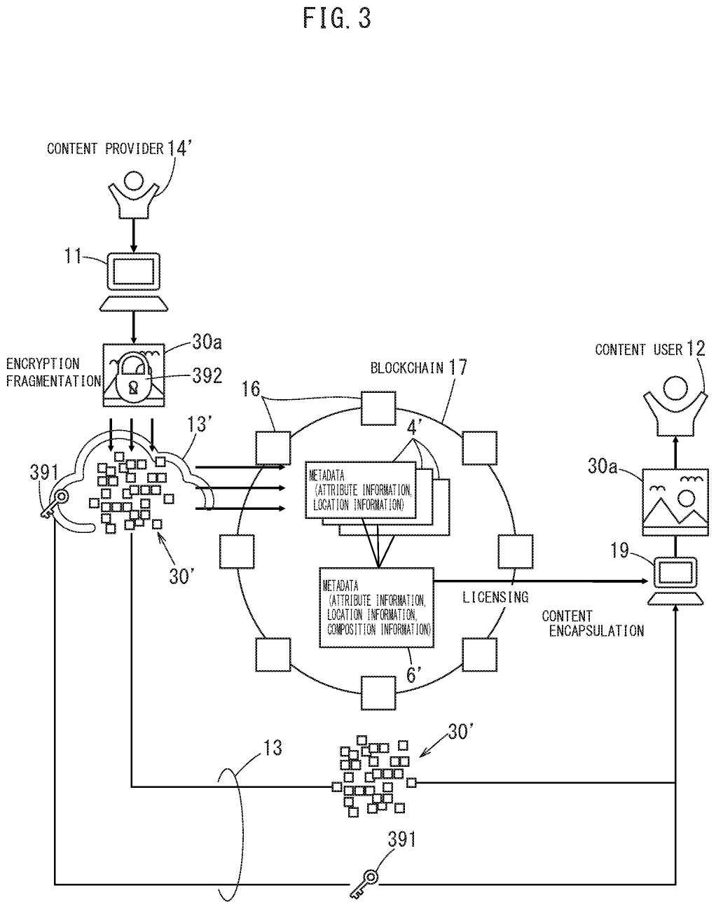

FIG. 3 is a block diagram showing a configuration of a content management system for applying a content contract in a blockchain according to another embodiment of the present invention. In FIG. 3, portions similar to or corresponding to those in the configuration of FIG. 1 are denoted by identical reference numerals, and description thereof is omitted. The above-described embodiment described an example in which the composer 32 or the composition device 34 edits and processes, or in other words, curates, multiple pieces of the raw content 30. However, it should be noted that in the present embodiment, the content 30 (content 30a, which is a still image, in FIG. 3) is divided into capsules 30′ of a predetermined very small level at the time when the provider (owner) 14′ uploads the content 30 to the Internet 13, such as a Web server, or a cloud environment 13′. For this reason, as the content contract 4′ of each very small capsule 30′, an aggregate of content contracts 4′ that is similar to the content contract 4 of each piece of content 30 and reproduces one still image 30a is denoted by reference numeral 6′, which is similar to the content contract 6.

Specifically, the content 30a is divided into units of 1 MB, for example, and in the content contracts 4′ of the very small capsules 30′, the metadata 31 is created by adding individual pieces of identification information to the location information 312 in the attribute information 311. With the content contracts 6′, a set including the identification information and the location information 612 (312) is arranged in the division order in the composition information 615 of the metadata portion 61, and when the enforcement condition 671 such as licensing is suitably satisfied, restoration of the content 30a is possible. On the other hand, the individual pieces of identification information are created randomly. Note that the enforcement condition 671 is not set for each divided piece of content 30a, but is set overall, as with the enforcement condition 371 of the content contract 4.

Accordingly, with the content management system of the present embodiment, even if the user 12 discovers some of the very small capsules 30′ of the content 30a on the Web (13, 13′) by luck, the identification information is random, and therefore unless the correct enforcement conditions 671 (371) are satisfied, the location information 612 (312) and the division order for many of the other portions of the content 30a will not be known and cannot be accurately restored. As a result, in the content management system of the present embodiment, the content 30a can be distributed while easily preventing unauthorized use, even without using a dedicated distribution server or the like. In particular, it is effective to disperse the Web site (13, 13′) that receives the divided very small capsules 30′.

Preferably, the content 30a is encrypted by the information processing apparatus 11 of the provider (owner) 14′ with a secret key 392 that can be decrypted with a publicly-known public key 391 (paired with the secret key 392), and is then divided into the above-described very small capsules 30′. With the information processing apparatus 19 of the user 12 of the content 30a, the divided content 30a is assembled inversely to the division order in accordance with the composition information 515 (615), and thereafter the assembled content 30a is decrypted with the public key 391.

Accordingly, with the content management system of the present embodiment, only the content provider (owner) 14′ can encrypt the content 30a with the secret key 392 that is paired with the public key 391, and therefore it is possible to provide the function of a digital signature for proving that the content 30a belongs to the provider (owner) 14′. Also, according to the content management system of the present embodiment, even if the key is publicly known, for example, even if the public key 391 is published on a Web site (13, 13′) on which the content 30a is published, the content 30a cannot be accurately decrypted unless all of the capsules 30′ (data or programs) divided to a very small size are present, and thus it is not possible to achieve the expected object of the data or the program, such as reproducing an image (the function of the content cannot be exhibited). Thus, according to the content management system of the present embodiment, it is possible to even further prevent unauthorized use. On the other hand, the key needed for decryption is a public key 391 that is publicly known from a Web site (13, 13′) or the like on which the content 30 is published, and according to the content management system of the present embodiment, a special configuration for managing the public key 391, such as the above-described management server, does not need to be provided, and for example, even an individual can freely sell the content 30 without relying on any site and without being charged a commission fee.

The content contract for a blockchain according to the present invention is a new content contract that is recorded in a blockchain, and by which an owner of one or more pieces of online content enforces ownership via the blockchain, including; a contract portion describing an enforcement condition for the content in the blockchain; a metadata portion in which information relating to the content is added; and a method portion describing a program code of an enforcement program for enforcing the ownership via the blockchain in accordance with the enforcement condition for the content. The metadata portion includes location information that is specific to the content and is for referencing an online external storage on a network different from the blockchain.

According to the above-described configuration, regarding browsing, quoting, downloading, and the like of any content online, such as one or more Web pages, and digital data and programs that are often acquired from the Web page, in order to avoid undesired (unintended) or unknown use, and to enforce ownership of the content, the owner of the content registers the content as a digital asset in a blockchain that has high identifiability and tampering resistance, and the owner uses the blockchain as a means for enforcing ownership.

Specifically, the new means for enforcing ownership of the present invention is recorded as a content contract (a digital asset) in a blockchain. Also, in the content contract, a contract portion describing enforcement conditions for enforcing ownership of the content in accordance with a transaction determined in advance in a blockchain such as a contract accompanying the exchange of a virtual currency such as Bitcoin, and a method portion describing an enforcement program for enforcing ownership in accordance with the enforcement conditions are described, a metadata portion of the appropriate content for which ownership is to be enforced is provided, and in the metadata portion, attribute information such as the name, author, and creation date and time of the content, which are basic information for ownership of the content, and location information, which should be noted, such as a URL or a URN for referencing the appropriate online external storage, which is on any network different from the blockchain, are described. Enforcement of ownership means using the content, obtaining profit through use of the content, and disposing of the content.

Here, if the content to be used is a Web page, for example, the content is a page such as a blog or news published on the Web, or a posted article on an SNS or the like. If the content to be used is a me, the content is a digital file that is provided online, such as a moving image file, an image file, or a text file. If the content to be used is a program, the content is a digital file that can be downloaded from online, such as a dynamic program for realizing a desired function, such as a script or a code for live broadcasting, a TV conference, a chat function, or the like, a library for JAVA (registered trademark) or the like, a conversion program such as an encoder, or a display program such as a Web browser or an e-book reader.

Accordingly, any owner (provider) of content can set content prepared so as to be publishable online as a highly-reliable digital asset and record the enforcement condition, that is, the asset value, due to the information processing apparatus of the owner accessing a blockchain, and any user can search for the content due to the information processing apparatus of the user accessing the blockchain, and anyone can allow the owner to enforce ownership, such as using the content, as long as the above-described enforcement condition is followed. The enforcement condition is the exchange price of the content using a virtual currency such as Bitcoin, an availability period, the number of people to whom the content is available, a specific user who designates use, or the like.

Moreover, it has conventionally been thought that anyone may view online content, and in particular, content published via a network such as the Internet, and there have been many cases in which use such as browsing, quoting, and downloading against the will of the owner has been performed. By contrast, according to the present invention, it is possible to publish content online, but since content for which processing for enforcing ownership such as licensing can be performed is purposely registered in a blockchain, content prepared at a location indicated by the location information stored in the attribute information of the content can be published with the technical features of tampering resistance, identifiability, availability, and publicness, which are achieved using the blockchain.

Accordingly, a large-scale centralized management database such as a content server need not be prepared, there is no longer a particular need for a special management server for encryption keys even if this kind of large-scale centralized management database is not used, and a revolutionary content providing system can be realized in which, for example, even an individual can freely sell self-produced films and self-produced lecture videos without relying on any site and without being charged a commission fee. Furthermore, the function of storing usage history and the like can also be ensured using the history information recorded in the blockchain, it is possible to manage how much of the content is used and how much the transaction cost is raised when a transaction is performed using virtual currency, and it is possible to provide content with an even higher value.

Also, with the content contract in a blockchain according to the present invention, enforcement of the ownership is licensing for use of the content by a user, a usage condition is described as the enforcement condition in the contract portion, and the enforcement program enforces the licensing in accordance with the usage condition.

Furthermore, a content provision method of the present invention is a content provision method for providing content stored in an external storage to a user, the method including: a step of recording one or more pieces of the content to be provided in the external storage; a step of recording a new content contract in a blockchain, the content contract being created through a step of describing location information specific to the content in the external storage in a metadata portion of a content contract, a step of describing a usage condition for the content in a contract portion of the content contract, and a step of describing, in a method portion of the content contract, a program code for an enforcement program for enforcing the content in the blockchain in accordance with the usage condition; a step in which an information processing apparatus of a user accesses the blockchain, obtains licensing under the usage condition, and obtains the location information; and a step in which the information processing apparatus of the user accesses the external storage of the location information and uses the content.

According to the above-described configuration, when an owner (provider) enforces ownership of content serving as a digital asset by registering location information, attribute information, or the like in a blockchain, it is possible to take the most advantage of the features of the blockchain, such as the high tampering resistance, and payment using virtual currency, in the use of the content, and obtainment of profit through use of the content. Also, by viewing the usage history, it is possible to devise improvements to and variation of the content, the digital asset value of content with a high usage frequency can be increased, and the like, and thus recognizing use as an enforcement of ownership can contribute to correct cost evaluation of the content, and thereby to the creation of better content.

Also, with the content contract in a blockchain according to the present invention, if a plurality of pieces of the content are combined, edited and processed, the location information of the respective pieces of content is arranged according to a predetermined logic or according to a predetermined rule and recorded in the metadata portion.

According to the above-described configuration, if multiple pieces of content are combined, edited and processed, that is, if multiple pieces of content are curated, in addition to the online location information of each piece of content, the display order is stored in the metadata if the content is, for example, a digital file, and the processing order is stored if the content is a program, in order to arrange the content according to a predetermined logic, or to arrange the content according to a predetermined rule. Layout information, annotations, and the like can also be added as needed. At this time, the usage (enforcement) conditions such as adding together the usage fees for multiple combined pieces of content, or applying the highest usage fee are also combined or compiled as necessary. Also, the enforcement program of the method portion obtains the licensing in accordance with the usage (enforcement) condition of the contract portion.

Accordingly, the added value of the content can be significantly improved by combining, editing and processing, that is, curating, multiple pieces of content. Also, even if the locations of the individual pieces of content are discovered, normal use is made impossible due to pictures and annotations not being visible even though the text can be read, or the intended content not being shown if the display order or the processing is not clear, and thus the added value obtained through curation cannot be received. As a result, unauthorized use can be prevented. Furthermore, multiple pieces of content can be handled collectively, and the load relating to system development for distribution and operation maintenance can also be reduced.

Furthermore, with the content contract in a blockchain according to the present invention, the plurality of pieces of content that are combined, edited and processed have already been recorded in a blockchain as the content contract.

According to the above-described configuration, the actual data of the pieces of content serving as the raw material that is curated (encapsulated) are stored online, the location information is registered along with the attribute information and the like in a blockchain, and thus the content is made into a digital asset in advance, and ownership is clear. Curation, for which unauthorized use was not conventionally suppressed as described above, can be performed safely by going through a procedure that conventionally did not exist for curation, namely combining pieces of content for which ownership is clear.

Accordingly, a content provider can perform curation (encapsulating) and can appropriately perform licensing of the raw content when providing content that can be obtained by combining any pieces of content or by asserting the content provider's opinion quoting views and opinions of a third party. That is, the provider's ownership of the raw content can be made clear, and distribution of income through billing or the like, tampering prevention measures, and the like can also be performed suitably.

Also, with the content contract in a blockchain according to the present invention, the content is divided to a predetermined very small level, random individual pieces of identification information are added thereto, and the pieces of location information associated with the individual pieces of identification information are arranged according to a division order and recorded in the metadata portion.

According to the above-described configuration, the metadata portion is created by dividing the content to a predetermined very small level, for example, in units of 1 MB, and adding individual pieces of identification information to each piece of location information. Also, a set including the identification information and the location information is arranged according to the division order in the metadata portion, and if an enforcement condition for licensing or the like is suitably satisfied, restoration of the content is possible. On the other hand, the individual pieces of identification information are created randomly.

Accordingly, even if a portion of the content on the Web is discovered by luck, the identification information is random, and therefore unless the correct enforcement condition is satisfied, the location information and division order of many of the other portions of the content will not be understood and accurate restoration cannot be performed. As a result, even if a dedicated distribution server or the like is not used, it is possible to easily distribute content while preventing unauthorized use. In particular, it is effective to disperse the Web site for receiving the divided content.

Furthermore, with the content contract in a blockchain according to the present invention, the content is encrypted using a secret key that can be decrypted using a publicly-known public key, and thereafter the content is divided to the predetermined very small level.

According to the above-described configuration, on the owner side, the content is encrypted with a secret key that can be decrypted with a publicly-known public key, and thereafter, the encrypted content is divided to a very small level. The user of the content assembles the divided content inversely to the dividing order and thereafter decrypts the content with the public key.

Accordingly, only the content owner can encrypt the content with the secret key that is paired with the public key, and therefore it is possible to provide the function of a digital signature that proves that the content belongs to the owner. Also, even if the key is publicly known, for example, even if a public key is published on a Web site on which the content is published, encryption cannot be performed accurately unless all of the divided data or programs are present, and thus the intended object of the data or programs cannot be achieved (the function of the content cannot be exhibited); for example, images cannot be reproduced. Thus, unauthorized use can be prevented. On the other hand, the key needed for decryption is a public key that is publicly known from the Web site on which the above-described content is published, and thus there is no need to provide a separate configuration for managing the public key, such as the above-described management server, and even an individual can freely sell content without relying on any site and without being charged a commission fee.

Also, the content contract in a blockchain according to the present invention is usage history that relates to the above-described content contract in a blockchain, the usage history being recorded in the blockchain, and being recorded accompanying use of the content.

According to the above-described configuration, each time licensing is obtained by a certain user and the content is used, the usage history is stored in the blockchain. Examples of the usage history include the usage date and time of each use, the address in the blockchain of the used content contract, the usage history data based on which the usage fee and the like were set, the specific address of a user, a specific address for the usage history data, and the like.

Accordingly, each user or the owner (provider) of the content can collect usage history information for each user by accessing these addresses. This makes it possible for each user to reference his or her own usage history at any time. For example, in the case of e-learning, the usage history is highly-reliable study status (growth) data that is resistant to tampering and according to which identification is possible, according to the technical features of the above-described blockchain, and thus the usage history can be used to issue a graduation certificate or a course completion certificate that may be useful for advancing education or finding employment. Furthermore, due to the dispersed nature and publicness of the blockchain, it is possible to store a record of studying at multiple institutions over one's lifetime, and thus even in a case of changing institutions, such as the case of advancing education, changing schools, studying abroad, or finding employment, the knowledge and skill of the user can be judged overall, and the knowledge that the user has learned can be evaluated also by a teacher, an educational institution, or an employing organization.

Also, the collected history data is highly anonymous data due to the technical features of the blockchain, and therefore the problem regarding the handling of personal information, which has conventionally been a problem in the collection of usage history data on the Web, can also be solved. For this reason, it is also possible to collect large-scale big data while protecting privacy.

Furthermore, with the content contract in a blockchain according to the present invention, the licensing performed by accepting the usage condition is performed using virtual currency in the blockchain.

According to the above-described configuration, the blockchain is infrastructure developed for the main purpose of exchanging virtual currency, and when the provider of the content performs licensing, the virtual currency is used as a registration fee in billing processing for continued use. Accordingly, the provider and the user can directly perform transactions without going through a specific service provider who provides a content selling service, and thus the need for commission fees and the like related to transactions can be eliminated. In this case, the usage conditions include not only the price, the availability period of the virtual currency, and the number of people to whom the content is available, but further usage conditions such as whether or not alteration including combination of the content is possible may be added to the usage conditions.

Also, a content management system of the present invention includes: a blockchain in which the above-described content contract is described as an object; an information processing apparatus of a provider of the content, the information processing apparatus being configured to create the content contract and record the created content contract in the blockchain; an information processing apparatus of a user, the information processing apparatus being configured to receive licensing of the content via the blockchain; an online external storage configured to store actual data of the content; and a network different from the blockchain, the network connecting the information processing apparatus of the user and the external storage.

According to the above-described configuration, the data of the content can be accessed via an appropriate network (online) when a transaction of any content is performed, but the content contract stored in the blockchain, which has high tampering resistance, is used in order to enforce ownership of the provider (owner), such as licensing.

Furthermore, in the content management system of the present invention, the content is study material.

According to the above-described configuration, an instructor who is the content provider installs the location information (URL, URN) of static content such as a lecture video or documents to be provided to a learner, who is the user, and thereby the information processing apparatus of the user, upon obtaining the licensing, can autonomously acquire the actual data of the needed content and the study material as intended by the instructor can be provided. Thus, a dedicated study management system or Web site does not need to be prepared, and e-learning can be provided continuously at a low cost and with high reliability. In particular, when e-learning is provided, conventionally, it has been necessary to provide a distribution server that stores all of the needed study materials, and furthermore includes a mechanism for billing payment. In contrast to this, with the present invention, as described above, the location information (URL, URN) of the needed content (study material) is installed in the content contract, and by merely performing licensing with the blockchain, which has high tampering resistance, the information processing apparatus of the user who has obtained permission autonomously collects the data of the content, and thus the need for a distribution server is eliminated. Also, the content management system of the present embodiment eliminates the need for a centralized server as well, and therefore billable e-learning can be implemented continuously by any organization, such as cram schools, preparatory schools, private enterprises, and individuals, not just dedicated educational institutions such as institutions of higher learning.

Also, in the content management system of the present invention, the content is a program for a study assistance function.

According to the above-described configuration, due to an instructor who is the content provider installing the location information (URL, URN) of dynamic content, such as a live lecture or a TV conference that is to be provided to a learner who is the user in the content contract, the information processing apparatus of the user can, upon obtaining licensing, autonomously acquire the program for the needed study assistance function, and thus the study content as intended by the instructor can be provided Thus, a dedicated study management system or Web site does not need to be prepared, and e-learning can be provided continuously at a low cost and with high reliability. In particular, when e-learning is provided, conventionally, it has been necessary to provide a distribution server that stores all of the needed study materials, and furthermore includes a mechanism for billing payment. In contrast to this, with the content management system of the present embodiment, as described above, the location information (URL, URN) of the needed program (study materials) is installed in the content contract, and by merely performing licensing with the blockchain, which has high tampering resistance, the information processing apparatus of the user who has obtained permission autonomously collects the content, and thus the need for a distribution server is eliminated. Also, the content management system of the present embodiment eliminates the need for a centralized server as well, and therefore billable e-learning can be implemented continuously by any organization, such as cram schools, preparatory schools, private enterprises, and individuals, not just dedicated educational institutions such as institutions of higher learning.

### INDUSTRIAL APPLICABILITY

With a content contract for a blockchain, a content management system using the content contract, and a content provision method according to the present invention, when a provider of content publishes content on a Web page, an SNS, or the like online, such as on the Internet, a content contract, which is a new tool for enforcing ownership according to the present invention, is recorded in a blockchain. A contract portion describing enforcement conditions for performing licensing, and a method portion describing an enforcement program for performing licensing in accordance with the above-described enforcement conditions are described in the content contract, and a metadata portion is provided in the content contract. Attribute information and location information such as a URL or URN for referencing an online external storage storing the actual data of the content are described in the metadata portion.

Accordingly, there is no need to prepare a large-scale centralized management database, or even a small-scale management server for merely managing encryption keys, and by publishing content prepared at a location of the location information by skillfully using the technical features of the blockchain, such as tampering resistance, identifiability, availability, and publicness, undesired browsing, quoting, and downloading can be prevented, which is preferable in content management.

What is claimed is:

1. A new content contract that is recorded in a blockchain, and by which an owner of one or more pieces of online content enforces ownership via the blockchain, comprising;
a contract portion describing an enforcement condition for the content in the blockchain;
a metadata portion in which information relating to the content is added; and
a method portion describing a program code of an enforcement program for enforcing the ownership via the blockchain in accordance with the enforcement condition for the content, and
the metadata portion includes location information that is specific to the content and is for referencing an online external storage on a network different from the blockchain.

2. The content contract in a blockchain according to claim 1, wherein
enforcement of the ownership is licensing for use of the content by a user, a usage condition is described as the enforcement condition in the contract portion, and the enforcement program enforces the licensing in accordance with the usage condition.

3. The content contract in a blockchain according to claim 1, wherein
if a plurality of pieces of the content are combined, edited and processed, the location information of the respective pieces of content is arranged according to a predetermined logic or according to a predetermined rule and recorded in the metadata portion.

4. The content contract in a blockchain according to claim 3, wherein
the plurality of pieces of content that are combined, edited and processed have already been recorded in a blockchain as the content contract.

5. The content contract in a blockchain according to claim 1, wherein
the content is divided to a predetermined very small level, random individual pieces of identification information are added thereto, and the pieces of location information associated with the individual pieces of identification information are arranged according to a division order and recorded in the metadata portion.

6. The content contract in a blockchain according to claim 5, wherein
the content is encrypted using a secret key that can be decrypted using a publicly-known public key, and thereafter the content is divided to the predetermined very small level.

7. A content contract, which is usage history that relates to the content contract in a blockchain according to claim 2, the usage history being recorded in the blockchain, and being recorded accompanying use of the content.

8. The content contract in a blockchain according to claim 7, wherein
the licensing performed by accepting the usage condition is performed using virtual currency in the blockchain.

9. The content contract in a blockchain according to claim 2, wherein
if a plurality of pieces of the content are combined, edited and processed, the location information of the respective pieces of content is arranged according to a predetermined logic or according to a predetermined rule and recorded in the metadata portion.

10. The content contract in a blockchain according to claim 9, wherein
the plurality of pieces of content that are combined, edited and processed have already been recorded in a blockchain as the content contract.

11. The content contract in a blockchain according to claim 2, wherein
the content is divided to a predetermined very small level, random individual pieces of identification information are added thereto, and the pieces of location information associated with the individual pieces of identification information are arranged according to a division order and recorded in the metadata portion.

12. The content contract in a blockchain according to claim 11, wherein
the content is encrypted using a secret key that can be decrypted using a publicly-known public key, and thereafter the content is divided to the predetermined very small level.

13. The content contract in a blockchain according to claim 2, wherein
the licensing performed by accepting the usage condition is performed using virtual currency in the blockchain.

14. A content management system comprising;
a blockchain in which the content contract according to claim 1 is described as an object;
an information processing apparatus of a provider of the content, the information processing apparatus being configured to create the content contract and record the created content contract in the blockchain;
an information processing apparatus of a user, the information processing apparatus being configured to receive licensing of the content via the blockchain;
an online external storage configured to store actual data of the content; and
a network different from the blockchain, the network connecting the information processing apparatus of the user and the external storage.

15. The content management system according to claim 14, wherein
the content is study material.

16. The content management system according to claim 14, wherein
the content is a program for a study assistance function.

17. A content provision method for providing content stored in an external storage to a user, the method comprising:
a step of recording one or more pieces of the content to be provided in the external storage;
a step of recording a new content contract in a blockchain, the content contract being created through a step of describing location information specific to the content in the external storage in a metadata portion of a content contract, a step of describing a usage condition for the content in a contract portion of the content contract, and a step of describing, in a method portion of the content contract, a program code for an enforcement program for enforcing the content in the blockchain in accordance with the usage condition;
a step in which an information processing apparatus of a user accesses the blockchain, obtains licensing under the usage condition, and obtains the location information; and
a step in which the information processing apparatus of the user accesses the external storage of the location information and uses the content.
